(19) United States
(12) Patent Application Publication
(10) Pub. No.: US 2009/0312493 A1
(43) Pub. Date: Dec. 17, 2009

(54) Polylactic acid composition

(75) Inventors: Chi-Juan Huang, Taipei (TW); Chia-I Liu, Taipei (TW)

Correspondence Address: BACON & THOMAS, PLLC, 625 SLATERS LANE, FOURTH FLOOR, ALEXANDRIA, VA, 22314-1176, US

(73) Assignees: Tatung Company, Taipei (TW); Tatung University, Taipei (TW)

(21) Appl. No.: 12/232,356

(22) Filed: Sep. 16, 2008

(30) Foreign Application Priority Data
Jun. 17, 2008 (TW) 097122590

(51) Int. Cl. C08L 29/04

(52) U.S. Cl. 525/58

(57) ABSTRACT

The present invention relates to a polylactic acid composition, which comprises a polylactic acid, a polyvinyl alcohol, and a grafted polylactic acid. In the present invention, the polylactic acid composition has an improved dyeing property, physical strength, crystal stability, and so forth. Hence, the composition of the present invention can be manufactured into textile fabrics having good strength by melt blowing or reeling.

### BACKGROUND OF THE INVENTION

1. Field of the Invention

The present invention relates to a polylactic acid composition and, more particularly, to a polylactic acid composition having stable crystallinity and good physical characteristics.

2. Description of Related Art

Currently, many people have been aware of that conventional plastic products are difficult to dispose in a biodegradable manner. Once these plastic products are discarded, they will cause environmental burdens and become a major source of environmental pollution. With the rise of environmental protection awareness, industries have begun to introduce, improve, and develop biodegradable products. Hence, biodegradable materials have gradually been applied in agriculture, forestry, fisheries and civil construction, disposable plastic bags, food containers and packaging materials, stationery, daily necessities and so on. Because biodegradable materials are used to protect the natural environment, the research also focuses on the recovery of these biodegradable materials.

Generally, biodegradable materials mean materials capable of being degraded into water and carbon dioxide in the natural environment. Among them, polylactic acid (PLA) is a novel biodegradable material, and it can be applied in the manufacture of textiles, cold drink cups and plastic bags, and so forth. However, heating (for example, repeated recrystallization) makes PLA transform into a transparent meta-stable structure, and thereby influences physical properties of PLA. In other words, after textile materials made of PLA are reeled and melt-blown into fabrics, the unstable PLA decreases the strength of the fibers as the storing period extends, resulting in fracture of the fabrics. Furthermore, since the textile materials having hydrophobic PLA added thereto have an increased hydrophobicity, they are difficult to bind with hydrophilic dyes, leading to inconsistency in textile dyeing.

### SUMMARY OF THE INVENTION

In view of the above-mentioned shortcomings, the object of the present invention is to provide a polylactic acid composition having improved hydrophilicity, dyeability, and dye-leveling. Compared with a single component of polylactic acid, the composition of the present invention has better physical properties. Besides, the crystallization behavior of the polylactic acid is stable in the composition of the present invention, and thereby is suitable for the reeling process and the melt-blowing process to yield textiles with stable strength.

To achieve the object, the present invention provides a polylactic acid composition comprising a polylactic acid; a polyvinyl alcohol; and a grafted polylactic acid, which is grafted with a C₃˜C₈ organic acid or acid anhydride.

In the above-mentioned polylactic acid composition, the organic acid can be represented by R₁—COOH. When R₁ is C₂˜C₇ alkenyl, the organic acid is an organic monoacid, for example acrylic acid, 3-butenic acid, crotonic acid, cis-2-methylbutenoic acid, hydrosorbic acid, and sorbic acid. When R₁ is C₂˜C₇ alkenylcarboxyl, the organic acid is an organic diacid or polyacid, or formed from acid anhydride due to dissociation or bond breaking, for example maleic acid, fumaric acid, and glutaconic acid.

In the above-mentioned polylactic acid composition, the amount of the polyvinyl alcohol can be in the range of 3˜50 wt %, and preferably is in the range of 15˜40 wt % based on the polylactic acid. The amount of the grafted polylactic acid can be in the range of 1˜99 wt %, and preferably is in the range of 20˜70 wt % based on the polyvinyl alcohol. More preferably, the amount of the grafted polylactic acid is in the range of 35˜55 wt % based on the polyvinyl alcohol. The average molecule weight of the polylactic acid is not limited, but preferably is in the range of 5,000˜900,000. The average molecule weight of the polyvinyl alcohol is not limited, but preferably is in the range of 22,000˜24,500. Besides, the amount of the organic acid in the grafted polylactic acid is preferably in the range of 0.001˜1 wt %.

Other objects, advantages, and novel features of the invention will become more apparent from the following detailed description when taken in conjunction with the accompanying drawings.

### BRIEF DESCRIPTION OF THE DRAWINGS

FIG. 1(a) is an electronic microscope picture showing fracture surface of the blend in the Comparative example;

FIG. 1(b) is an electronic microscope picture showing fracture surface of the composition in Example 2 of the present invention;

FIG. 2(a) is a 3-cycle differential scanning calorimetry (DSC) graph of neat polylactic acid;

FIG. 2(b) is a 3-cycle differential scanning calorimetry (DSC) graph of the blend in the Comparative example;

FIG. 2(c) is a 3-cycle differential scanning calorimetry (DSC) graph of the composition in Example 2 of the present invention;

FIG. 3(a) is a top view of the test specimen made of neat polylactic acid after the dyeing test;

FIG. 3(b) is a side view of the test specimen made of neat polylactic acid after the dyeing test;

FIG. 3(c) is a top view of the test specimen made of the composition of the present invention after the dyeing test; and

FIG. 3(d) is a side view of the test specimen made of the composition of the present invention after the dyeing test.

### DETAILED DESCRIPTION OF THE PREFERRED EMBODIMENT

The present invention will be described in more detail with the accompanying drawings.

The present inventors added polyvinyl alcohol into polylactic acid for the purpose of improving the physical properties of the polylactic acid. However, because polylactic acid is hydrophobic and polyvinyl alcohol is hydrophilic, the compatibility of polylactic acid and polyvinyl alcohol is poor. In order to improve the compatibility, the present inventors prepared a compatilizer, which is polylactic acid grafted with organic acid. When the compatilizer is added in the mixture of polylactic acid and polyvinyl alcohol, the compatibility of polylactic acid and polyvinyl alcohol can be increased. Therefore, the strength and stability of the textiles made of the above-mentioned can be promoted.

The present invention provides a polylactic acid composition, which comprises a polylactic acid; a polyvinyl alcohol; and a grafted polylactic acid, which is grafted with a C₃˜C₈ organic acid or acid anhydride.

In the above-mentioned polylactic acid composition, the amount of the polyvinyl alcohol is preferably in the range of 3˜50 wt % based on the polylactic acid. For example, the amount of the polyvinyl alcohol can be 5, 10, 15, 20, 25, 30, 35, 40, or 45 wt % based on the polylactic acid. If the amount of the polyvinyl alcohol is less than 3 wt % (i.e. the lower limit of the range), the physical properties of the polylactic acid composition, for example hardness, fragility and so on, can not be improved. If the amount of the polyvinyl alcohol is more than 50 wt % (i.e. the upper limit of the range), the incompatibility of the composition dramatically deteriorates physical and mechanical properties of the polylactic acid composition.

In the above-mentioned polylactic acid composition, the amount of the grafted polylactic acid is preferably in the range of 1˜99 wt % based on the polyvinyl alcohol. For example, the amount of the grafted polylactic acid can be 10, 20, 30, 40, 50, 60, 70, 80, or 90 wt % based on the polylactic acid. If the amount of the grafted polylactic acid is less than 1 wt % (i.e. the lower limit of the range), the polylactic acid is not compatible with the polyvinyl alcohol in the composition. If the amount of the grafted polylactic acid is more than 99 wt % (i.e. the upper limit of the range), the polylactic acid composition easily becomes fragile, thereby narrowing the utility range of the polylactic acid composition.

In the above-mentioned polylactic acid composition, the grafted polylactic acid is grafted with an organic acid. Preferably, the organic acid has a carbon-carbon double bond (C═C), and it can be represented by R₁—COOH. When R₁ is C₂˜C₇ alkenyl, the organic acid is an organic monoacid, for example acrylic acid, 3-butenic acid, crotonic acid, cis-2-methylbutenoic acid, hydrosorbic acid, and sorbic acid. When R₁ is C₂˜C₇ alkenylcarboxyl, the organic acid is an organic diacid or polyacid, or is formed from acid anhydride due to dissociation or bond breaking, for example maleic acid, fumaric acid and glutaconic acid.

The foregoing polylactic acid composition can be prepared by any well-known method in the art. For example, the method includes electrochemical deposition, in situ chemical polymerization, power dispersion, solution blending, melt blending and so forth.

Since polylactic acid belongs to the class of polyester, it is difficult to bind with dyes after reeling, and thereby level-dyeing textiles can not be easily obtained. However, the polylactic acid composition of the present invention comprises not only polyvinyl alcohol capable of improving the polarity of the composition, but also organic acid-grafted polylactic acid conducive to enhancing basic dyes of the adhesion to the composition. For example, if maleic acid-grafted polylactic acid is used, the carboxyl group of the maleic acid will increase the dyeing intensity of the whole composition, as shown in the following formula 1.

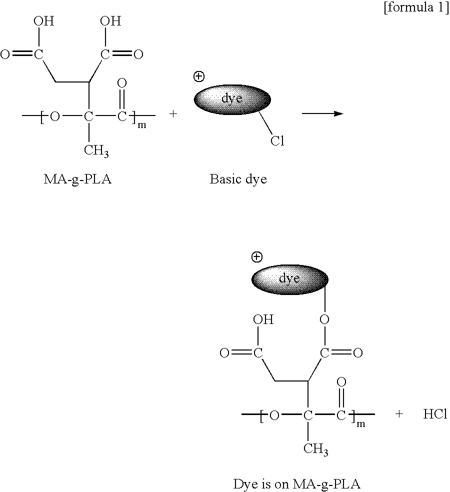

Because of the specific embodiments illustrating the practice of the present invention, a person having ordinary skill in the art can easily understand other advantages and efficiency of the present invention through the content disclosed therein. The present invention can also be practiced or applied by other variant embodiments. Many other possible modifications and variations of any detail in the present specification based on different outlooks and applications can be made without departing from the spirit of the invention.

### EXAMPLE

### Synthesis of Grafted Polylactic Acid

The grafted polylactic acid can be made of maleic acid and polylactic acid. For example, to a torque rheometer at 190° C., polylactic acid (for example, any commercial polylactic acid having average molecular weight in the range of 5,000˜900,000) and an initiator (having the amount of 0.01˜5 wt % based on the polylactic acid) were added. After free radicals released, maleic acid (having 5˜20 times the amount of the initiator) was added to the torque rheometer. Under stirring at the speed of 20 rpm for 10 mins, maleic acid-grafted polylactic acid was obtained, as shown in the following scheme 1. The used initiator is not limited, and includes 2,2-azobis-isobutyrionitrile (AIBN), dicumyl peroxide (DCP) and benzoyl peroxide (BPO), for example.

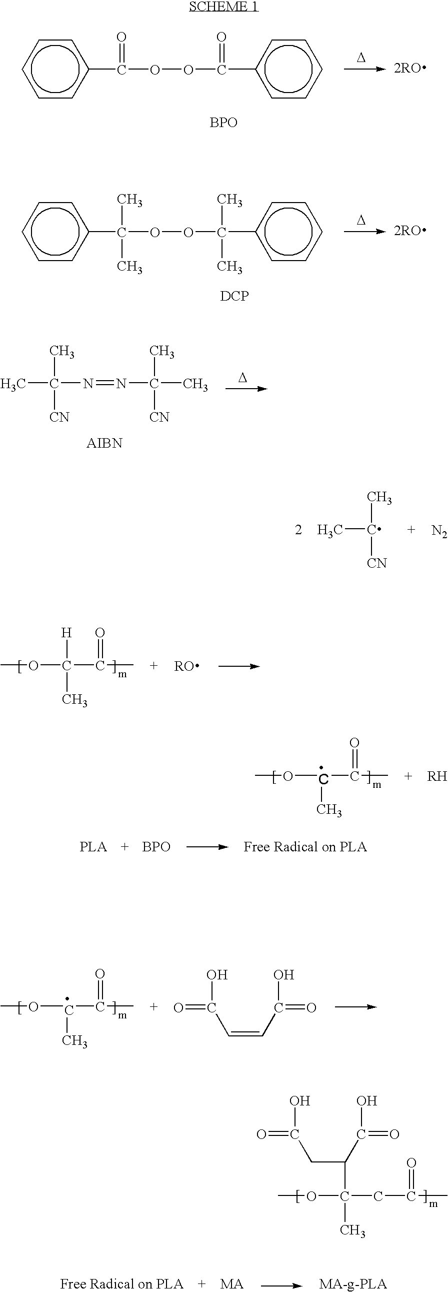

According the above-mentioned scheme, polylactic acid can be grafted with maleic acid. However, in the present invention, the organic acid grafted to polylactic acid is not limited to maleic acid, but includes any organic monoacid, diacid or polyacid having a short carbon chain (i.e. C₃˜C₈) with C═C bonds, or any acid anhydride dissociated or bond-broken into the foregoing organic acids.

### EXAMPLE 1

### Preparation of the Polylactic Acid/Polyvinyl Alcohol/Grafted Polylactic Acid Composition 1

Polylactic acid (for example, any commercial polylactic acid having average molecular weight in the range of 5,000˜900,000), polyvinyl alcohol (having average molecular weight of 22,000˜24,500) and the prepared grafted polylactic acid mentioned above were blended by single-screw extruder at 160° C., and then the polylactic acid/polyvinyl alcohol/grafted polylactic acid composition was obtained. In the composition, the amount of the polyvinyl alcohol was 5 wt % based on the polylactic acid, and the amount of the grafted polylactic acid was 5wt % based on the polyvinyl alcohol.

### EXAMPLE 2

### Preparation of the Polylactic Acid/Polyvinyl Alcohol/Grafted Polylactic Acid Composition 2

The composition of the present example is prepared in the same manner as Example 1, except the amount of the polyvinyl alcohol was 25 wt % based on the polylactic acid and the grafted polylactic acid was 45 wt % based on the polyvinyl alcohol.

### EXAMPLE 3

### Preparation of the Polylactic Acid/Polyvinyl Alcohol/Grafted Polylactic Acid Composition 2

The composition of the present example is prepared in the same manner as Example 1, except the amount of the polyvinyl alcohol was 50 wt % based on the polylactic acid and the grafted polylactic acid was 99 wt % based on the polyvinyl alcohol.

### COMPARATIVE EXAMPLE

### Preparation of the Polylactic Acid/Polyvinyl Alcohol Blend

The blend of the present Comparative example is prepared in the same manner as Example 1, except the amount of the polyvinyl alcohol was 50 wt % based on the polylactic acid and the grafted polylactic acid was not added therein.

### EXPERIMENTAL EXAMPLE 1

### Observation of the Fracture Surface

The fracture surfaces of the compositions and the blend prepared according to the above-mentioned were observed by using an electronic microscope.

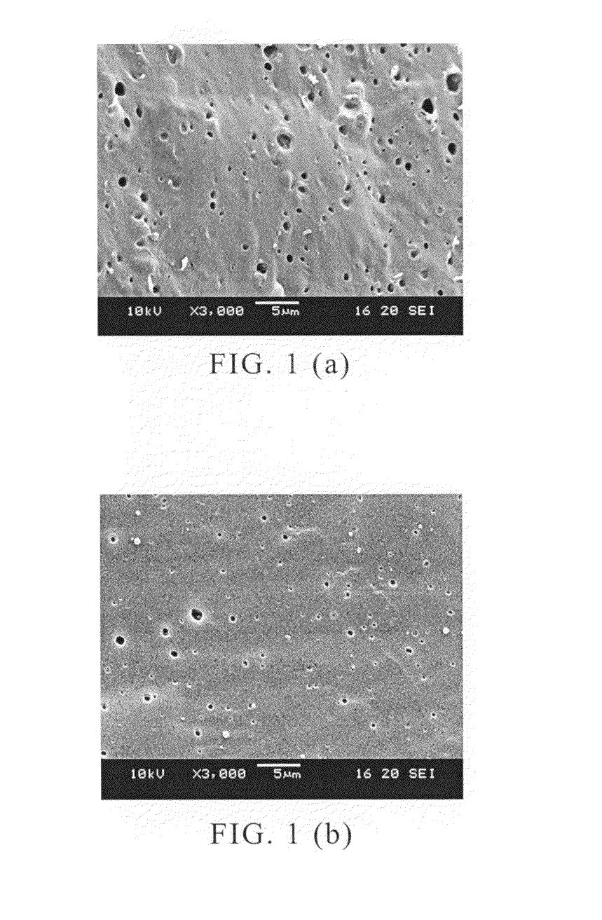

First, FIG. 1(a) is an electronic microscope picture of the fracture surface of the blend prepared in Comparative example. In Comparative example, the blend contains only polylactic acid and polyvinyl alcohol without grafted polylactic acid. However, owing to the hydrophobicity of the polylactic acid (belonging the class of polyester) and the hydrophilicity of the polyvinyl alcohol (having hydroxyl groups, i.e. —OH), interface debonding and spalling occur obviously on the fracture surface of the polylactic acid/polyvinyl alcohol blend. Therefore, many large pores occur on the fracture surface as shown in FIG. 1(a).

FIG. 1(b) is an electronic microscope picture of the fracture surface of the composition prepared in Example 2. In Example 2, the composition comprises not only polylactic acid and polyvinyl alcohol, but also grafted polylactic acid. Even though the hydrophobic polylactic acid is blended with the hydrophilic polyvinyl alcohol, the presence of the organic acid-grafted polylactic acid can assist the blending of the polylactic acid and the polyvinyl alcohol, and thereby improve interface debonding and spalling occurring in the blend of Comparative example. It can be evidenced in the comparison between FIGS. 1(a) and 1(b) that the size and the number of the pores occurring in the composition of Example 2 both are obviously lower than those occurring in the blend of Comparative example.

In view of the above-mentioned, the grafted polylactic acid used in the composition of Example 2 can efficiently improve the compatibility of the polylactic acid and the polyvinyl alcohol, and thereby reduce the spalling of the polyvinyl alcohol particles.

### EXPERIMENTAL EXAMPLE 2

### Analysis of the Crystallization

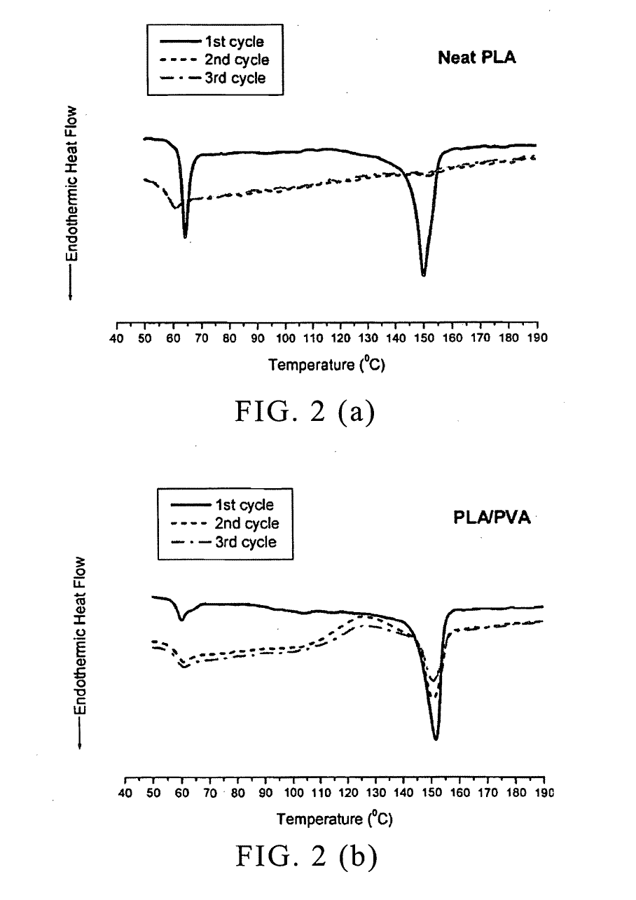

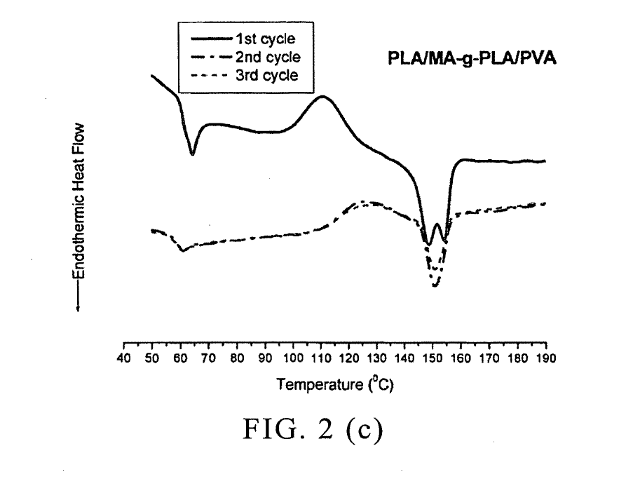

The neat polylactic acid, the blend of Comparative example and the composition of Example 2 were analyzed by differential scanning calorimetry (DSC) for 3 cycles. The results are shown as FIG. 2(a), FIG. 2(b) and FIG. 2(c), respectively.

FIG. 2(a) is a 3-cycle differential scanning calorimetry (DSC) graph of neat polylactic acid. As shown in FIG. 2(a), the neat polylactic acid tends toward uncrystallization and has no melting peak after three times of the heating-cooling cycles.

FIG. 2(b) is a 3-cycle differential scanning calorimetry (DSC) graph of the blend of Comparative example. As shown in FIG. 2(b), the smooth recrystallizing and melting peaks occur during the second and third cycles of the blend of Comparative example. It is understood that polyvinyl alcohol is beneficial for recystallization of polylactic acid during the heating-cooling cycles.

FIG. 2(c) is a 3-cycle differential scanning calorimetry (DSC) graph of the composition of Example 2. As shown in FIG. 2(c), the obvious recrystallizing and melting peaks occur during three cycles of the composition of Example 2. Besides, two melting peaks appear during the first cycle, and they respectively are 153° C. and 147° C. which are helix α-phase and sheet β-phase according to the scientific literature. However, these two peaks are combined into a single peak during the second and third cycles. In other words, the composition develops from a meta-stable system into a stable system. That is to say, the α-phase and β-phase of the polylactic acid can occur by controlling the added amount of the grafted polylactic acid (i.e. 1˜99 wt % based on the polyvinyl alcohol), and they tend towards a stable system during several times of the healing-cooling cycle. Hence, the composition of Example 2 can still maintain its crystallized structure in the stable system after several cycles.

The polylactic acid composition of the present invention can have improved crystallization of the polylactic acid, and also have good physical properties. Therefore, the composition of the present invention can be used in diversified and extensive application.

### EXPERIMENTAL EXAMPLE 3

### Dyeing Test

The polylactic acid/maleic acid-grafted polylactic acid/polyvinyl alcohol composition of the present invention and the neat polylactic acid were used as a material to prepare a test specimen (3 cm×3 cm×0.4 cm), respectively. The test specimens were dipped in a solution of a black basic dye at 100° C. for 45 mins, and then dried.

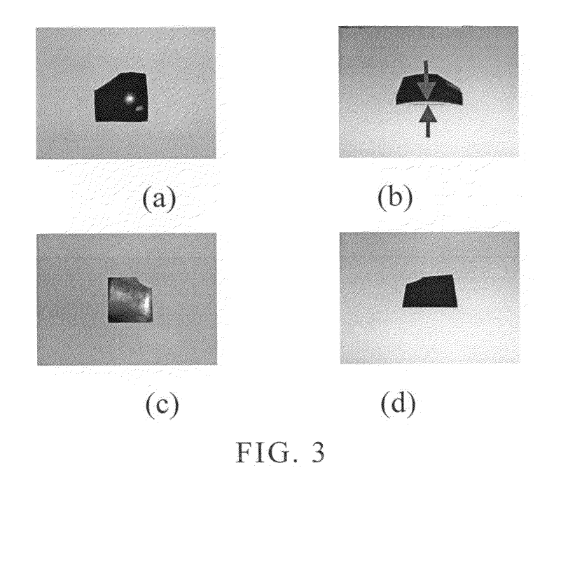

FIGS. 3(a) and 3(b) illustrate that expansion and deformation occur in the dyed test specimen made of the neat polylactic acid. FIGS. 3(c) and 3(d) show that the specimen made of the composition of the present invention exhibits stable size and uniform color. Hence, the composition of the present invention can overcome the shortcomings such as expansion, deformation, difficult dyeing and so on occurring in neat polylactic acid.

Although the present invention has been explained in relation to its preferred embodiment, it is to be understood that many other possible modifications and variations can be made without departing from the scope of the invention as hereinafter claimed.

1. A polylactic acid composition comprising:
a polylactic acid;
a polyvinyl alcohol; and
a grafted polylactic acid, which is grafted with a C₃-C₈ organic acid or acid anhydride.
wherein, the polylactic acid composition is used to bind with dyes.

2. The polylactic acid as claimed in claim 1, wherein the organic acid is represented by R₁-COOH, in which R₁ is C₂-C₇ alkenyl, or C₂-C₇ alkenylcarboxyl.

3. The polylactic acid as claimed in claim 1, wherein the amount of the polyvinyl alcohol is in the range of 3-50 wt % based on the weight of the polylactic acid.

4. The polylactic acid as claimed in claim 1, wherein the amount of the polyvinyl alcohol is in the range of 15-40 wt % based on the weight of the polylactic acid.

5. The polylactic acid as claimed in claim 1, wherein the amount of the grafted polylactic acid is in the range of 1-99 wt % based on the weight of the polyvinyl alcohol.

6. The polylactic acid as claimed in claim 1, wherein the amount of the grafted polylactic acid is in the range of 20-70 wt % based on the weight of the polyvinyl alcohol.

7. The polylactic acid as claimed in claim 1, wherein the amount of the grafted polylactic acid is in the range of 35-55 wt % based on the weight of the polyvinyl alcohol.

8. The polylactic acid as claimed in claim 1, wherein the weight average molecule weight of the polylactic acid is in the range of 5,000-900,000.

9. The polylactic acid as claimed in claim 1, wherein the weight average molecule weight of the polyvinyl alcohol is in the range of 22,000-24,500.

10. The polylactic acid as claimed in claim 1, wherein the amount of the organic acid is in the range of 0.001-1 wt % based on the weight of the grafted polylactic acid.

11. The polylactic acid as claimed in claim 1, wherein the organic acid is selected from the group consisting of acrylic acid, 3-butenic acid, crotonic acid, cis-2-methylbutenoic acid, hydrosorbic acid, and sorbic acid.

12. (canceled)

13. (canceled)

14. (canceled)

15. A dyed polylactic acid composition, comprising:
a polylactic acid;
a polyvinyl alcohol;
a grafted polylactic acid, which is grafted with a C₃-C₈ organic acid or acid anhydride; and
a basic dye, which is bonded to the carboxyl group of the organic acid or acid anhydride.

16. The dyed polylactic acid composition as claimed in claim 15, wherein the organic acid is represented by R₁-COOH, in which R₁ is C₂-C₇ alkenyl, or C₂-C₇ alkenylcarboxyl.

17. The dyed polylactic acid composition as claimed in claim 15, wherein the amount of the polyvinyl alcohol is in the range of 3-50 wt% based on the weight of the polylactic acid, and the amount of the grafted polylactic acid is in the range of 1-99 wt% based on the weight of the polyvinyl alcohol.

18. The dyed polylactic acid composition as claimed in claim 15, wherein the weight average molecule weight of the polylactic acid is in the range of 5,000-900,000, and the weight average molecule weight of the polyvinyl alcohol is in the range of 22,000-24,500.

19. The dyed polylactic acid composition as claimed in claim 15, wherein he amount of the organic acid is in the range of 0.001-1 wt% based on the weight of the grafted polylactic acid.

20. The dyed polylactic acid composition as claimed in claim 15, wherein the organic acid is selected from the group consisting of acrylic acid, 3-butenic acid, crotonic acid, cis-2-methylbutenoic acid, hydrosorbic acid, sorbic acid, maleic acid, fumaric acid, and glutaconic acid.

21. The composition of claim 1 which is a fabric.

22. The dyed polylactic acid composition of claim 15 which is a fabric.
